(19) United States
(12) Patent Application Publication
(10) Pub. No.: US 2002/0143891 A1
(43) Pub. Date: Oct. 3, 2002

(54) Method and apparatus for a mobile phone with internet link

(76) Inventors: Wayne Huang, San Diego, CA (US); Hugh Wang, San Diego, CA (US); Ed Zhong, San Diego, CA (US); Simon Chen, San Diego, CA (US)

Correspondence Address: PHILIP K. YU, REGISTERED PATENT ATTORNEY, 20955 PATHFINDER ROAD, STE. 160, DIAMOND BAR,, CA, 91765, US

(21) Appl. No.: 09/818,075

(22) Filed: Mar. 27, 2001

(51) Int. Cl. G06F 15/16; G06F 15/177

(52) U.S. Cl. 709/217; 709/203; 709/221; 709/249

(57) ABSTRACT

A method and apparatus for using a mobile phone to customize user interface is disclosed. The method comprises first providing a default user interface screen on the mobile phone in a local memory. Upon power-up by a first user, the mobile phone displays the first user interface screen for a first user of the mobile phone. Then, the mobile phone can make a data call to a first web server through a global computer information network, e.g. the Internet. The phone can brows a first desired web page at the first web server. If selected, the phone duplicates the first desired web page to the local memory as the default user interface for the first user, such that when the mobile phone is powered up by the first user, the mobile phone displays the desired web page.

### FIELD OF INVENTION

1. The present invention relates to mobile phones and more particularly relates to mobile phones which can browse a global computer information network such as the Internet.

### ART BACKGROUND

2. Mobile phones are becoming quite ubiquitous nowadays. At the early stages, mobiles phones are only capable of voice communications between the parties. However, as people depend more and more on the Internet for communications and data access, it is only a matter of time before mobility and the Internet converge as one. A hand-held device with both mobile communications and Internet data access will allow people to access data, e.g. e-mail or the Web, from the Internet, virtually anywhere reachable through a mobile phone.

3. While existing wireless communication standards have facilitated the progress of mobile communications, they are ill-suited for the upcoming broadband wireless technology. Current generations of wireless services, e.g. 2G or 2½ G digital services, can only accommodate certain amount of high-speed data transmission. The yet-to-be launched 3^{rd} generation (3G) of wireless services promises to achieve high-speed transmission of voice and data, including mobile audio, video and e-commerce. When 3G phones and networks are deployed with “wireless access protocol” (“WAP”), wireless devices will be able to have secure access to text-based information, including Web pages, and e-mail and with WAP, such transmission can run over most wireless networks, including CDPD, CDMA, GSM and TDMA. For more information on the development of various generations of wireless technology, reference is made to a book, entitled “CDMA IS-95 FOR CELLULAR AND PCS: Technology, Economics and Services,” by Lawrence Harte, McGraw-Hill Telecommunications, 1999, which is incorporated herein by reference. An article in the October issue of Red Herring, page 314, entitled “3G WIRELESS EXPLAINED,” by Alan Zeichick, also offers some information on the 3G development. The disclosure in this article is also incorporated herein by reference.

4. FIG. 1 is a simplified diagram illustrating how data is transferred between a mobile phone and a web server. Cell phone client 100 first transmits a WAP message 105 to cell tower 110. Cell tower 110 then communicates by microwave or copper to cell provider's network 115. Cell provider's network 115, through WAP gateway 120, translates the WAP message into HTTP (“hypertext transfer protocol”) message and forwards the HTTP message to the Internet 130. . The message is then forwarded to web server 150 through Internet service provider 140. Web server 150 decodes the HTTP message and generates a response in WML (“Wireless Mark-up Language”). The response is sent by ISP 140, through the Internet 130 to the cell provider's WAP gateway 120, which repackages the HTTP message and sent to cell tower 110 for transmission to cell phone client 100.

5. As wireless phones begin to promise more performance, consumers are going to demand more features and services. For example, wireless carriers have implemented their mobile phones with their respective local menu screens such that upon power-up by the user, the mobile phone will display a pre-programmed menu, e.g. phone menu or fixed “portal” menu, by the carrier. If the user desires to get on the Internet, additional key strokes will allow the user to brows the Net. While this entry method allows the user to access the Internet, it is not desirable due to lack of flexibility, since the menu is pre-programmed by the wireless carrier. This rigidity does not allow the user, nor any other parties such as the Internet Content Provider (ICP) and Internet Service Provider (ISP), to customize the menu or the web page.

### SUMMARY OF THE PRESENT INVENTION

6. A method and apparatus for using a mobile phone to customize user interface is disclosed. The method comprises first providing a default user interface screen on the mobile phone in a local memory. Upon power-up by a first user, the mobile phone displays the first user interface screen for a first user of the mobile phone. Then, the mobile phone can make a data call to a first web server through a global computer information network, e.g. the Internet. The phone can brows a first desired web page at the first web server. If selected, the phone duplicates the first desired web page to the local memory as the default user interface for the first user, such that when the mobile phone is powered up by the first user, the mobile phone displays the desired web page.

7. Additional users of the mobile phone can use the same methodology to alter the default page by browsing and storing their desired default pages in the phone's local memory. Upon initial authentication, the default page will be whichever default page pre-stored by the user.

### BRIEF DESCRIPTION OF THE DRAWINGS

FIG. 1 is a simplified diagram showing the path of wireless Internet data.

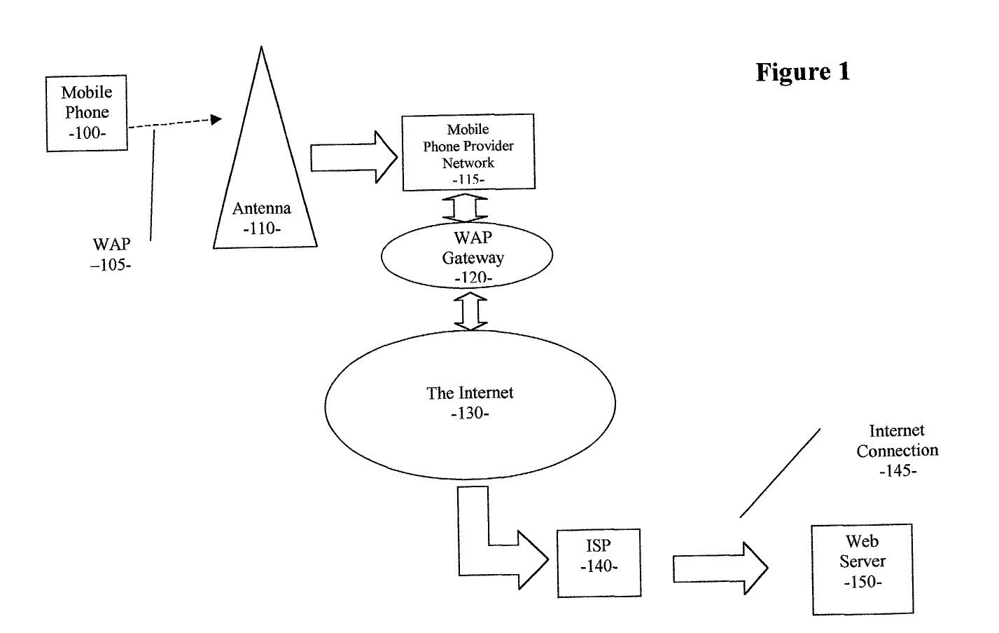

FIG. 2 is a simplified diagram showing the software system architecture of the present invention.

FIG. 3 is a simplified diagram showing the flow of the software system of the present invention.

FIG. 4 is a simplified diagram showing another embodiment of the present invention.

### DETAILED DESCRIPTION OF THE PREFERRED EMBODIMENT

8. A method and system for a mobile phone with Internet links is disclosed. In the description that follows, numerous items are set forth in detail to provide a more thorough understanding of the present invention. It will be apparent, however, to one ordinarily skilled in the art that the present invention may be practiced without these specific details. In other instances, well-known features have been described in general terms so as not to obscure the present invention.

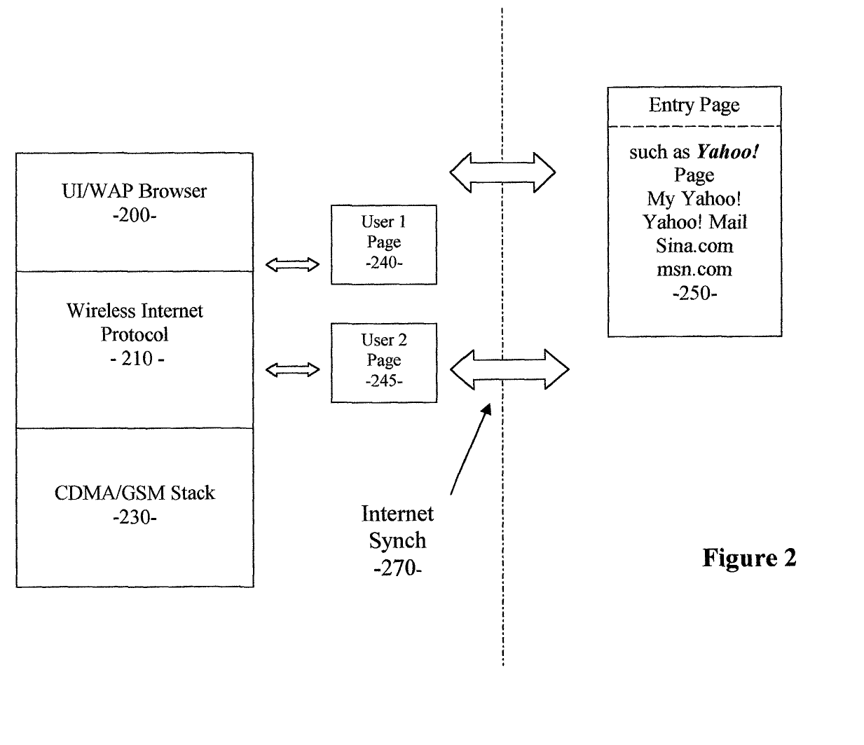

9. Reference is to FIG. 2, where a simplified software system architecture for the present invention is shown. At the server side, block 250 represents a personalized web page readily available from various portal sites, such as Yahoo's MyYahoo, Sina.com's MySina or Microsoft's www.msn.com, where an Internet client can sign on to obtain electronic mail or customize his or her preferred news information. Such personalized webs have been quite popular among the consumers through their PCs, since they can now access their e-mail or customized information from any PC with the help of an Internet browser such as Microsoft's IE5 or Netscape's Navigator.

10. At the client side, the mobile phone in accordance with the present invention has a software system architecture with the following major components. At the basic level, CDMA/GSM Stack 230 is a software program that handles connection with the mobile carrier's networks, in either CDMA or GSM operating environment. As should be appreciated by those skilled in the art of mobile communications, stack 230 is used to provide connection and hence must comply with international standards governing such CDMA or GSM communication.

11. Wireless Internet Protocol Stack 210 is a software program such as WAP or CHFTML that supports the interaction between the CDMA/GSM Stack 230 and UI/WAP Browser 200.

12. At a higher lever, UI/WAP Browser 200 is a software program that facilitates user interface and web browsing. It should be apparent to those skilled in the art that other browsers may be used to achieve the same functionality. Users of the mobile phones can specify their personalized pages (240, 245) so that upon power-up, WAP browser 210 displays a personalized web page from the web server 250.

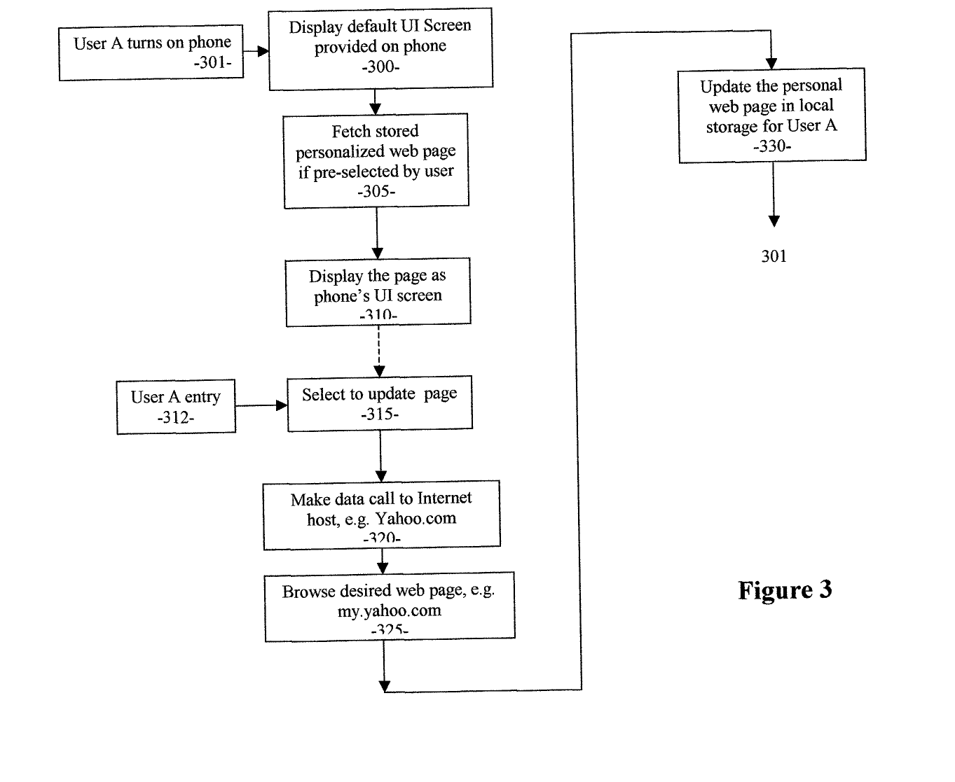

13. FIG. 3 is a diagram showing the flow upon power-up, where a user can customize the UI (“user interface”) screen on the mobile phone and then display the page on the mobile phone. Upon power-up by the user (301), the mobile phone first displays a default user interface screen (300). Such initial UI screens are usually provided, and thus dictated, by the network carrier, e.g. AT&T® or Verizon™. The carrier may also provide a plurality of default pages, if the phone is to be used by multiple users, e.g. different members of the household. Upon selection, the phone will display the UI screen based on a user (310) upon authentication.

14. In accordance with the present invention, the user can now enter to select and update the UI screen (312, 315). This is achieved by making data call to the an Internet host such as Yahoo® or MSN.com®. Upon browsing to a desired web page such as my.yahoo.com, the user can make that web page a customized personal page on the mobile phone (375). Such customization will cause the personal web page to be stored in the phone's local storage (330). The next time the same user turns on the phone (300, 301), the phone will display the customized web page. Furthermore, if different users customize their respective web pages on the phone, subject of course to the size of the local memory, the phone will display the stored customized web page based on the identity of the user upon login or authentication.

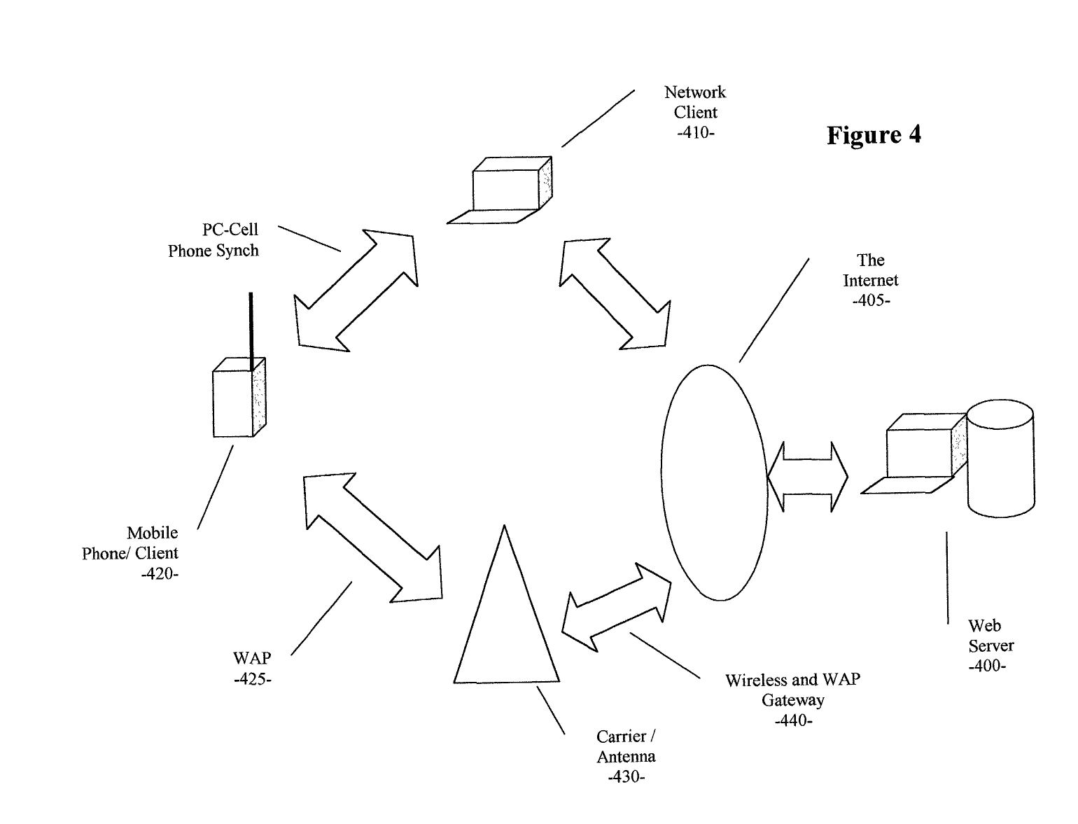

15. FIG. 4 shows the mobile phone in accordance with the present invention as it interacts with various information clients, such as PC or PDA. In this environment, the web server 400 such as Yahoo.com can serve client 410, e.g. PC or PDA, through the network of Internet 405. The web server 400 can also serve client 420, e.g. mobile phone, through the wireless/WAP network 420, 425 and the carrier 430. However, in contrast to the conventional system, the carrier 430 now operates merely as a “pipe” to pass information from the web server 400 to the mobile client 420. This methodology affords users flexibility to customize what they see as they wish, instead of subjecting themselves to the mercy of the carrier.

16. Referring to FIG. 4, the PC/PDA client 410 is used to customize the personal web page on the web server 400 through the Internet 405. Such customization by the PC/PDA client obviates the need for the mobile phone client 420, which may have only a limited set of functions in comparison to a PC, to access the web server 400 for customization. After a web page is customized, the mobile phone 420 can make connection to the web server 400 and customize the initial page as described above.

17. Obviously, numerous modifications and variations of the present invention are possible in light of the above teachings. It is therefore to be understood that within the scope of the appended claims, the invention may be practiced otherwise than as specifically described herein.

What is claimed is:

1. A method of using a mobile phone to customize user interface through a global computer information network, comprising:
a) providing a default user interface screen on the mobile phone in a local memory;
b) upon power-up by a first user, displaying the first user interface screen for a first user of the mobile phone;
c) making a data call to a first web server through a global computer information network;
d) browsing a first desired web page at the first web server;
e) duplicating the first desired web page to the local memory as the default user interface for the first user, such that when the mobile phone is powered up by the first user, the mobile phone displays the desired web page.

2. The method according to claim 1, further comprising:
f) making another data call to a second web server through the global computer information network;
g) browsing a second desired web page at the second web server;
h) duplication the second desired web page to the local memory as the default user interface for the second user, such that when the mobile phone is powered up by the second user, the mobile phone displays the second desired web page.

3. The method according to claim 1, wherein the first desired web page at the first web server is initially set up by the first user through a network client.

4. The method according to claim 2, wherein the second web page at the second web server is initially set up by the second user through a network client.

5. A mobile phone, comprising:
a transmitter for transmitting a transmit digital audio signal;
a receiver for receiving a receive digital audio signal;
an audio processor coupled to the transmitter and to the receiver;
a processor coupled to the transmitter, the receiver and the audio processor;
a first memory to store a software program for controlling the processor, the software program being adapted to perform the following:
a) providing a default user interface screen on the mobile phone in a local memory;
b) upon power-up by a first user, displaying the first user interface screen for a first user of the mobile phone;
c) making a data call to a first web server through a global computer information network;
d) browsing a first desired web page at the first web server;
e) duplicating the first desire web page to the local memory as the default user interface for the first user, such that when the mobile phone is powered up by the first user, the mobile phone displays the desired web page.

6. The mobile phone of claim 5, the software program being adapted to further perform the following:
f) making another data call to a second web server through the global computer information network;
g) browsing a second desired web page at the second web server;
h) duplication the second desired web page to the local memory as the default user interface for the second user, such that when the mobile phone is powered up by the second user, the mobile phone displays the second desired web page.

7. The mobile phone of claim 5, wherein the first desired web page at the first web server is initially set up by the first user through a network client.

8. The mobile phone of claim 6, wherein the second web page at the second web server is initially set up by the second user through a network client.
